(19) United States
(12) Patent Application Publication
(10) Pub. No.: US 2015/0023547 A1
(43) Pub. Date: Jan. 22, 2015

(54) INFORMATION PROVIDING SYSTEM HAVING CONTENT PROVIDING APPARATUS AND TERMINAL APPARATUS, AND CONTROL METHOD THEREOF

(71) Applicant: SAMSUNG ELECTRONICS CO., LTD., Suwon-si (KR)

(72) Inventors: Byung-ho CHA, Suwon-si (KR); Yong-kuk YOU, Seoul (KR); Jun-bum SHIN, Suwon-si (KR); Yong-cheol YANG, Seoul (KR)

(73) Assignee: SAMSUNG ELECTRONICS CO., LTD., Suwon-si (KR)

(21) Appl. No.: 14/295,591

(22) Filed: Jun. 4, 2014

(30) Foreign Application Priority Data
Jul. 19, 2013 (KR) 10-2013-0085281

(51) Int. Cl. G06T 1/00

(52) U.S. Cl. CPC G06T 1/0021
USPC 382/100

(57) ABSTRACT

An information providing system including a content providing apparatus, a display apparatus, and a terminal apparatus is provided. The information providing system includes: a content providing apparatus to generate a watermark, insert the watermark into a predetermined location of a content on a real time basis, and transmit the content; a display apparatus to receive the content into which the watermark is inserted and output the content; and a terminal apparatus to receive input of at least one of an image and sound of the content comprising the watermark from the display apparatus, detect the watermark, extract identification information from the watermark, and output corresponding additional information. Accordingly, information is provided to a user by inserting and extracting the watermark in various methods.

### CROSS-REFERENCE TO RELATED APPLICATIONS

This application claims priority benefit from Korean Patent Application No. 10-2013-0085281, filed on Jul. 19, 2013, in the Korean Intellectual Property Office, the disclosure of which is incorporated herein by reference in its entirety.

### BACKGROUND

1. Field

The following description relates to an information providing system including a content providing apparatus and a terminal apparatus, and a control method thereof, and more particularly, to an information providing system including a content providing apparatus and a terminal apparatus, which may provide information using identification information included in a content, and a control method thereof.

2. Description of the Related Art

Digital watermarking is a technique that inserts information having invisibility into a multimedia content, and is designed to be robust to a variety of image deformation. The information transmission feature of the watermarking is used to trace the content, and in particular, the watermarking may require robustness so that it may be detected even when an image is photographed by a camcorder. By maximizing the information transmitting ability besides the tracking ability, the digital watermarking may transmit information users desire. For example, the digital watermarking inserts a watermark into a printout such that the user photographs the printout using a camera of the user's terminal apparatus, identifies a corresponding ID, and obtains the information that the user desires.

Such a watermarking technique may be used to extract information from an advertisement and a promotional material provided as a still image or sound. However, the watermarking technique does not consider a content that is provided as a moving image. Also, a user scenario that may be played out by connection between a display apparatus and a terminal apparatus is not considered.

On the other hand, as the electronic technologies have been developed, a large format display has been developed in recent years. However, it is difficult for the user to obtain a whole image of the large format display at a normal distance from the display.

Accordingly, there is a need for a method for detecting a watermark inserted into a large format display and extracting information on a moving image content.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide an information providing system including a content providing apparatus and a terminal apparatus, which inserts and extracts a watermark in various ways, thereby providing information to a user, and a control method thereof.

According to an aspect of an exemplary embodiment, there is provided a content providing apparatus including: a generator to generate a watermark; an inserter to insert the watermark into a predetermined location of a content on a real time basis; and a communicator to transmit the content into which the watermark is inserted.

The watermark may be in a form of at least one of sound and an image.

When the watermark is in the form of the image, the inserter may divide a frame constituting the content in a plurality of areas and may insert the watermark into the plurality of areas.

According to an aspect of another exemplary embodiment, there is provided a terminal apparatus including: an inputter to receive input of at least one of an image and sound of a content including a watermark from a display apparatus; a controller to detect the watermark from the at least one of the image and the sound of the content and extract identification information from the watermark; and an outputter to search for additional information corresponding to the identification information and output the additional information.

The terminal apparatus may further include a storage to store at least one portion of additional information, and the controller may search for the additional information corresponding to the identification information from the at least one portion of additional information stored in the storage.

The terminal apparatus may further include a communicator to transmit the identification information to a server, and the communicator may receive additional information which is searched using the identification information from the server.

According to an aspect of still another exemplary embodiment, there is provided an information providing system including: a content providing apparatus to generate a watermark, insert the watermark into a predetermined location of a content on a real time basis, and transmit the content; a display apparatus to receive the content into which the watermark is inserted and output the content; and a terminal apparatus to receive input of at least one of an image and sound of the content including the watermark from the display apparatus, detect the watermark, extract identification information from the watermark, and output corresponding additional information.

When the watermark is in a form of an image, the content providing apparatus may divide a frame constituting the content into a plurality of areas and insert the watermark into the plurality of areas.

According to an aspect of still another exemplary embodiment, there is provided a control method of a content providing apparatus, the method including: generating a watermark; inserting the watermark into a predetermined location of a content on a real time basis; and transmitting the content into which the watermark is inserted.

The watermarks may be in a form of at least one of sound and an image.

The inserting may include, when the watermark is in the form of the image, dividing a frame constituting the content into a plurality of areas and inserting the watermark into the plurality of areas.

According to an aspect of still another exemplary embodiment, there is provided a control method of a terminal apparatus, the method including: receiving input of at least one of an image and sound of a content including a watermark from a display apparatus; detecting the watermark from the at least one of the image and the sound of the content, and extracting identification information from the watermark; and searching for additional information corresponding to the identification information and outputting the additional information.

The method may further include searching for the additional information corresponding to the identification information from at least one portion of additional information which is stored.

The method may further include: transmitting the identification information to a server; and receiving additional information which is searched using the identification from the server.

According to the above-described exemplary embodiments, information may be provided to the user by inserting and extracting the watermark in various methods.

### BRIEF DESCRIPTION OF THE DRAWINGS

The above and/or other aspects will be more apparent by describing in detail exemplary embodiments, with reference to the accompanying drawings, in which:

FIG. 1 is a view illustrating an information providing system according to an exemplary embodiment;

FIG. 2 is a view illustrating an information providing system according to another exemplary embodiment;

FIG. 3 is a block diagram illustrating a content providing apparatus according to an exemplary embodiment;

FIG. 4 is a block diagram illustrating a terminal apparatus according to an exemplary embodiment;

FIG. 5 is a block diagram illustrating a terminal apparatus according to another exemplary embodiment.

FIG. 6 is a view to illustrate a method for inserting a watermark according to an exemplary embodiment;

FIG. 7 is a view to illustrate a method for inserting a watermark according to another exemplary embodiment;

FIG. 8 is a flowchart illustrating a control method of a content providing apparatus according to an exemplary embodiment;

FIG. 9 is a flowchart illustrating a control method of a terminal apparatus according to an exemplary embodiment;

FIG. 10 is a flowchart illustrating a control method of a content providing apparatus according to another exemplary embodiment;

FIG. 11 is a flowchart illustrating a method for extracting a watermark according to an exemplary embodiment; and

FIG. 12 is a flowchart illustrating a method for extracting a watermark according to another exemplary embodiment.

### DETAILED DESCRIPTION

Hereinafter, exemplary embodiments will be described in greater detail with reference to the accompanying drawings.

In the following description, same reference numerals are used for the same components when they are depicted in different drawings. The matters defined in the description, such as detailed construction and components, are provided to assist in a comprehensive understanding of exemplary embodiments. Thus, it is apparent that exemplary embodiments may be carried out without those specifically defined matters. Also, functions or components known in the related art are not described in detail since they would obscure the exemplary embodiments with unnecessary detail.

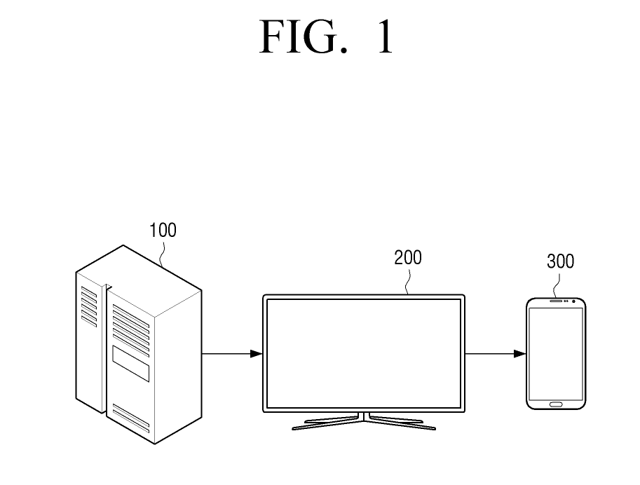

FIG. 1 is a view illustrating an information providing system according to an exemplary embodiment. Referring to FIG. 1, the information providing system includes a content providing apparatus 100, a display apparatus 200, and a terminal apparatus 300.

The content providing apparatus 100 generates a watermark, inserts the watermark into a predetermined location of a content, and transmits the content into which the watermark is inserted to the display apparatus 200. A manufacturer of the content may generate a basic form of the watermark using a tool. When the manufacturer designates an insertion location in the content, the content providing apparatus 100 may generate the watermark to be inserted and insert the watermark into the designated location of the content. The content providing apparatus 100 may transmit the content into which the watermark is inserted.

According to another exemplary embodiment, the content providing apparatus 100 may receive identification information and selection of a designated location from the manufacturer, generate a watermark including the identification information, and inserts the watermark into the designated location of the content. In the case of the content that is transmitted on a real time basis like a moving image, the content providing apparatus 100 may insert the watermark into the designated location of the content on a real time basis, and may transmit the content into which the watermark is inserted. Also, the content providing apparatus 100 may detect an appropriate location and may insert the watermark into the location.

The watermark may be in the form of at least one of sound and an image. When the watermark is in the form of sound, the watermark may be sound having a frequency other than an audible frequency. According to circumstances, the content providing apparatus 100 may analyze the sound of the content and insert the watermark in the form of the sound into an area where a change in the sound amplitude is great.

When the watermark is in the form of an image, the content providing apparatus 100 may analyze a frequency of an image frame and may insert the watermark in the form of the image into a high frequency area. The watermark in the form of the image is not an image that is distinguished with person's naked eyes and may be comprised of image signals.

The content providing apparatus 100 may be implemented by using an electronic apparatus such as a personal computer (PC), a notebook computer, a tablet PC, a server, etc.

The display apparatus 200 may receive the content into which the watermark is inserted through a communicator (not shown). The display apparatus 200 includes a controller (not shown) and the controller decodes the content and displays it. The display apparatus 200 may detect the watermark. The display apparatus 200 receives a user command to detect the watermark, and hooks the content and detects the watermark. When hooking the content, the display apparatus 200 may sample the content. When the watermark is detected, the display apparatus 200 extracts the identification information from the watermark. The extracted identification information is transmitted to the terminal apparatus 300.

The identification information may be transmitted from the display apparatus 200 to the terminal apparatus 300 in a wireless and or wired communication method. For example, in the wireless communication method, the display apparatus 200 may include a communicator (not shown). The communicator (not shown) may include at least one of a wireless local area network (LAN) module (not shown) and a short-range communication module (not shown). The wireless LAN module may be connected with the terminal apparatus 300 in a place where a wireless access point (AP) is installed under the control of the controller (not shown). The wireless LAN module supports the wireless LAN standard (IEEE802.11x) of IEEE. The short-range communication module may communicate between the display apparatus 200 and the terminal apparatus 300 wirelessly within a short range under the control of the controller. The short-range communication method may include Bluetooth, infrared data association (IrDA), or other direct communication method such as an ad-hoc, and etc.

The display apparatus 200 may be a large format display (LFD), for example, and may be implemented by using a digital TV (DTV), a digital album, a kiosk, etc.

The terminal apparatus 300 receives the identification information from the display apparatus 200 and searches for corresponding information. The terminal apparatus 300 may store a variety of information and corresponding identification information, and may search for information corresponding to the received identification information. When the information corresponding to the identification information is searched, the terminal apparatus 300 outputs the searched information.

For example, the variety of information may be product information, advertisement information, personal information, work information, etc. The terminal apparatus 300 may be implemented by using an electronic device such as a tablet PC, a portable multimedia player (PMP), a personal digital assistant (PDA), a smartphone, a mobile phone, a digital album, a game console, etc.

The information providing system may include a separate information search server.

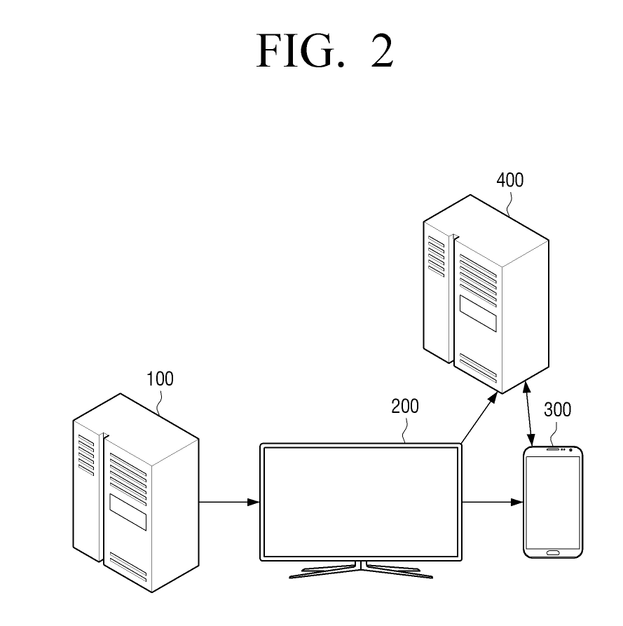

FIG. 2 is a view illustrating an information providing system according to another exemplary embodiment. Referring to FIG. 2, the information providing system may include a content providing apparatus 100, a display apparatus 200, a terminal apparatus 300, and a server 400.

As described in FIG. 1, the content providing apparatus 100 transmits a content including a watermark to the display apparatus 200. The display apparatus 200 may receive and output the content including the watermark, and may detect the watermark according to a user command. The display apparatus 200 may detect identification information from the detected watermark and may transmit the identification information to the server 400. The identification information may be encrypted and transmitted to the server 400. The server 400 may receive the encrypted identification information and decrypts the identification information, and may search for additional information corresponding to the identification information. The server 400 may transmit the searched additional information to the display apparatus 200 or the terminal apparatus 300. The display apparatus 200 may receive and output the additional information, and may transmit the additional information to the terminal apparatus 300.

When transmitting the identification information to the server 400, the display apparatus 200 may transmit information on the terminal apparatus 300. The server 400 may search for the additional information corresponding to the identification information and may transmit the searched additional information to the terminal apparatus 300 using the information on the terminal apparatus 300. The terminal apparatus 300 may output the additional information. As described in FIG. 1, the additional information may be product information, advertisement information, personal information, work information, etc.

According to another exemplary embodiment, the display apparatus 200 and the terminal apparatus 300 may be connected with each other in a wireless communication method. In this case, the display apparatus 200 may transmit the extracted identification information to the terminal apparatus 300 in a wireless communication method. The terminal apparatus 300 transmits the identification information to the server 400. At this time, the identification information may be encrypted and then transmitted. The server 400 may decrypt the identification information, search for the additional information, and then transmit the additional information to the terminal apparatus 300. The terminal apparatus 300 may output the received additional information.

According to still another exemplary embodiment, the terminal apparatus 300 may receive a content which is output from the display apparatus 200. For example, the terminal apparatus 300 may photograph an image which is output from the display apparatus 200 using a camera, and may receive input of sound using a microphone. The terminal apparatus 300 may detect the watermark from at least one of the image and the sound of the input content. The terminal apparatus 300 may extract the identification information from the detected watermark and may transmit the identification information to the server 400. At this time, the identification information may be encrypted and transmitted. The server 400 may search for the additional information using the identification information. The server 400 may transmit the searched additional information to the terminal apparatus 300. The terminal apparatus 300 may output the additional information. For example, when the additional information is audio information, the additional information may be output through a speaker, and, when the additional information is image information, the additional information may be output through a display panel. Also, the additional information may be output through the speaker and the display panel simultaneously.

Hereinafter, the content providing apparatus 100 and the terminal apparatus 300 will be explained.

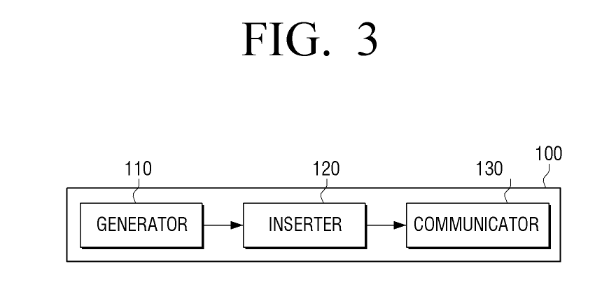

FIG. 3 is a block diagram illustrating a content providing apparatus according to an exemplary embodiment. Referring to FIG. 3, the content providing apparatus 100 includes a generator 110, an inserter 120, and a communicator 130.

The generator 110 generates a watermark. When a manufacturer sets information including identification information and corresponding information and a form of the watermark, the watermark may be generated according to a predetermined process. The watermark may be in the form of sound or in the form of an image. However, the watermark may be generated with a specific frequency band so that the watermark may not be detected by a general user while a content is being played back.

The inserter 120 inserts the watermark into a predetermined location of a content on a real time basis. The predetermined location may be a specific location or a plurality of locations of the content image when the watermark is in the form of an image, and may be a location of the content sound where an amplitude is great or a change in the amplitude is great when the watermark is in the form of sound. The inserter 120 may insert the watermark at the same time of manufacturing the content, or may insert the watermark on a real time basis while encoding the content.

The communicator 130 transmits the content into which the watermark is inserted. The display apparatus 200 receives and outputs the content into which the watermark is inserted. The terminal apparatus 300 may receive the content into which the watermark is inserted and which is output from the display apparatus 200, and may detect the watermark.

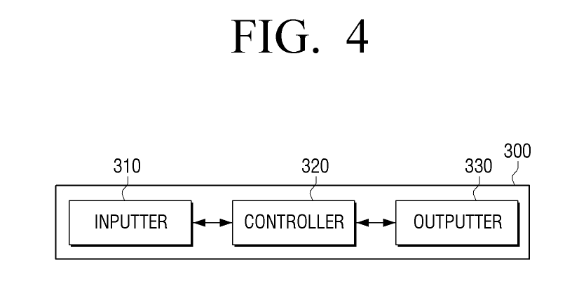

FIG. 4 is a block diagram illustrating a terminal apparatus according to an exemplary embodiment. Referring to FIG. 4, the terminal apparatus 300 includes an inputter 310, a controller 320, and an outputter 330.

The inputter 310 may receive input of at least one of an image and sound of a content including a watermark from the display apparatus 200. The watermark may be in the form of sound or an image. In the case of the watermark in the form of sound, the display apparatus 200 may output the watermark included in the content when outputting the sound of the content. In the case of the watermark in the form of an image, the display apparatus 200 may output the watermark included in the content when outputting the image of the content.

The controller 320 detects the watermark from at least one of the image and the sound of the input content. The controller 320 extracts identification information from the detected watermark. For example, the identification information is about the currently output content, thing, character, advertisement, etc and refers to information for searching for corresponding information from an information database.

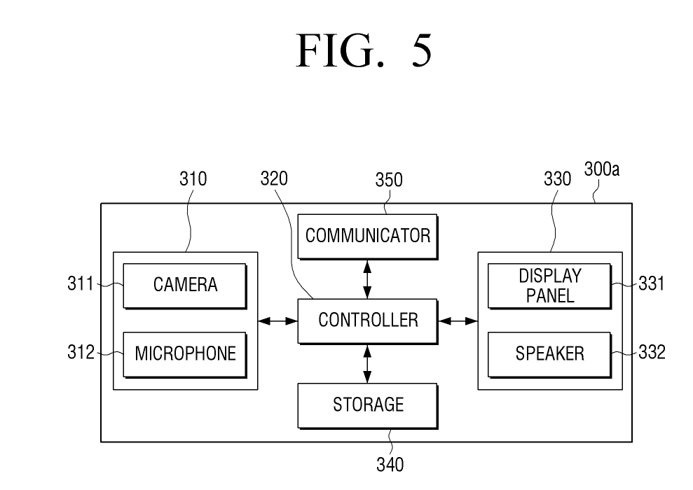

The outputter 330 searches for additional information corresponding to the identification information and outputs the additional information. The additional information corresponding to the identification information may be searched from information stored in the terminal apparatus 300, or may be searched through the server 400. The additional information may be in the form of sound or in the form of an image. The additional information in the form of the image may be a still image or a moving image. A detailed configuration of the terminal apparatus 300 will be explained with reference to FIG. 5.

FIG. 5 is a block diagram illustrating a terminal apparatus according to another exemplary embodiment.

Referring to FIG. 5, a terminal apparatus 300a may include an inputter 310, a controller 320, an outputter 330, a storage 340, and a communicator 350. The terminal apparatus 300a may include only one of the storage 340 and the communicator 350. The inputter 310 may include at least one of a camera 311 and a microphone 312. The outputter 330 may include at least one of a display panel 331 and a speaker 332.

The camera 311 photographs a content image which is output from the display apparatus 200. The photographed content image includes a watermark in the form of an image. The controller 320 detects the watermark from the photographed content image through an image signal processing operation, and extracts identification information. The terminal apparatus 300a may include a plurality of cameras. In this case, all of the cameras may photograph the content image or only one of the cameras may photograph the content image.

The microphone 312 receives a content sound which is output from the display apparatus 200. The content sound includes a watermark in the form of sound. The controller 320 detects a watermark from the content sound through an audio signal processing operation, and extracts identification information.

The storage 340 may store at least one portion of additional information. For example, the storage 340 may store a famous painting database including information on a famous painting such as a title, a painter, a year when the painting was painted, an explanation, etc. When the display apparatus 200 displays a content regarding a famous painting, the terminal apparatus 300a photographs the content including the watermark using the camera 311, and extracts identification information. The controller 320 may search for information on the famous painting corresponding to the extracted identification information from the storage 340.

The storage 340 may store control programs and applications to control the terminal apparatus 300a or the controller 320. Hereinafter, the term “storage” includes a read only memory (ROM), a random access memory (RAM), or a memory card which is mountable/dismountable on/ from the terminal apparatus 300a (for example, an SD card and a memory stick). Also, the storage may include a non-volatile memory, a volatile memory, a hard disk driver (HDD), or a solid state drive (SSD).

The communicator 350 may transmit the identification information extracted by the controller 320 to the server. The server may receive the identification information from the terminal apparatus 300a, search for additional information corresponding to the identification information, and transmit the additional information to the terminal apparatus 300a. The communicator 350 may receive the searched additional information from the server.

According to circumstances, the communicator 350 may transmit the watermark which is detected by the controller 320 to the server. The server may extract identification information from the received watermark, search for additional information corresponding to the identification information, and transmit the additional information to the terminal apparatus 300a.

For example, the communicator 350 may include at least one of a short-range communication module (not shown) and a wireless LAN module (not shown). The wireless LAN module may be connected with the internet in a place where a wireless AP (not shown) is installed under the control of the controller 320. The wireless LAN module supports the wireless LAN standard (IEEE802.11x) of IEEE.

The short-range communication module may communicate with the terminal apparatus 300a and the display apparatus wirelessly within a short range under the control of the controller 320. The short-range communication method may include Bluetooth, IrDA, and a direct communication method such as an ad-hoc, and etc. According to an exemplary embodiment, the display apparatus may detect the watermark according to a user command and transmit the watermark to the terminal apparatus 300a. The terminal apparatus 300a may extract identification information from the received watermark, and may search for additional information corresponding to the extracted identification information. According to another exemplary embodiment, the display apparatus may detect the watermark and extract identification information from the detected watermark. The extracted identification information may be transmitted to the terminal apparatus 300a. Alternatively, the display apparatus may transmit the extracted identification information and information on the terminal apparatus 300a to the server, and the server may search for additional information corresponding to the identification information and may transmit the additional information to the terminal apparatus 300a.

The display panel 331 outputs the additional information when the additional information is image information. The display panel 331 may be implemented by using various display units such as a liquid crystal display (LCD) panel, a plasma display panel (PDP), an organic light emitting diode (OLED), a vacuum fluorescent display (VFD), a field emission display (FED), an electro luminescence display (ELD), etc.

The display panel 331 may be implemented by using a general display panel without a touch input function, or may be implemented by using a touch display panel which may detect a user manipulation using a proximity sensor or a touch sensor. When the display panel 331 is implemented by using the touch display panel, the display panel 331 may receive input of at least one touch gesture through a user's body (for example, user's finger including user's thumb) or an inputting tools which may be sensed (for example, a stylus pen).

The speaker 332 outputs the additional information when the additional information is sound information. When the additional information includes both the image information and the sound information, the additional information is output through the display panel 331 and the speaker 332.

When the watermark is in the form of an image, the watermark may be inserted into a content in various methods.

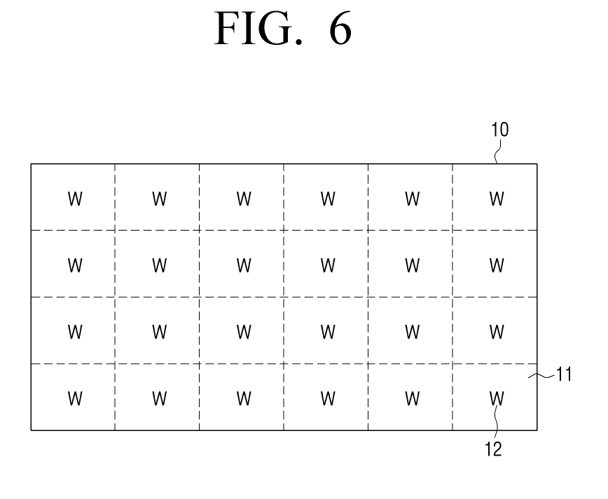

FIG. 6 is a view to illustrate a method for inserting a watermark according to an exemplary embodiment.

Referring to FIG. 6, a watermark is inserted into a content screen. When the watermark is in the form of an image, the terminal apparatus may photograph the content screen into which the watermark is inserted and may detect the watermark using the photographed image. However, in the case of a large format display, it may be difficult for the terminal apparatus to photograph the whole screen displayed on the display apparatus. Also, the watermark is inserted so that it may not be detected by the user as described above. Accordingly, when the watermark is inserted only into a specific location of the content screen, the user does not know the location of the watermark and thus has a difficulty in photographing the watermark with the terminal apparatus.

Therefore, a frame 10 constituting the content is divided into a plurality of areas and the watermark 12 is inserted into the plurality of areas as shown in FIG. 6. A size of one area 11 may be set considering a general viewing environment. For example, it is common that the user views the content displayed on the display apparatus at a distance of about 2-3 m from the display apparatus. Accordingly, the size of the area may be set considering a screen size of the display apparatus that is photographed by a camera of the terminal apparatus which is located at a distance of about 2-3 m from the display apparatus.

That is, the size of one area 11 is determined considering a size of a screen area of the display apparatus that is photographed at a predetermined distance from the display apparatus. The frame 10 constituting the content is divided into a plurality of areas according to the determined size. The watermark is inserted into the plurality of areas. For example, the watermark including identification information corresponding to a content title, a cast, and information on the content may be inserted in the above-described methods. The watermark may be inserted in a different method according to additional information.

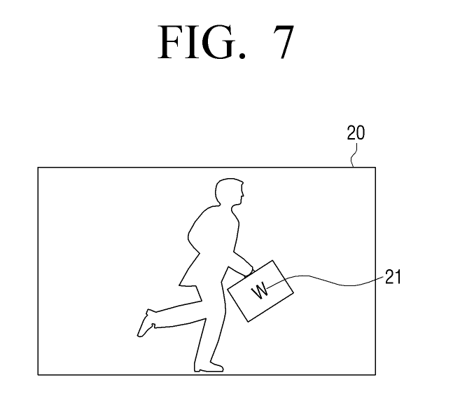

FIG. 7 is a view to illustrate a method for inserting a watermark according to another exemplary embodiment.

Referring to FIG. 7, an image frame 20 includes a scene featuring a person who is running with a bag. When additional information is about the bag, the user may concentrate on the bag and thus it is not necessary to insert the watermark in the method shown in FIG. 6. That is, the watermark may be inserted into a bag area 21 of the image frame 20. For example, when the additional information is about a brand, a price, and advertisement of the bag, the watermark may be inserted in the method described in FIG. 7.

The method for inserting the watermark has been described so far. Hereinafter, a control method of a content providing apparatus and a control method of a terminal apparatus will be explained.

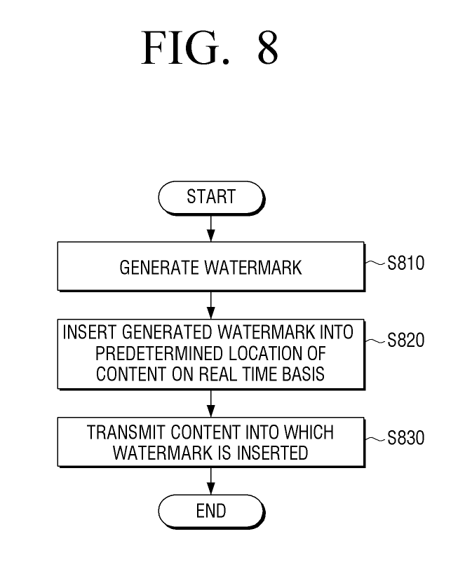

FIG. 8 is a flowchart illustrating a control method of a content providing apparatus according to an exemplary embodiment.

Referring to FIG. 8, the content providing apparatus generates a watermark (S810). The watermark may be in the form of at least one of sound and an image. The watermark may be generated to include identification information corresponding to additional information and may be generated so that the watermark may not be detected by the user. For example, when the watermark is in the form of sound, the watermark may be generated with a frequency band other than an audible frequency, and, when the watermark is in the form of an image, the watermark may be generated with a high frequency band.

The content providing apparatus inserts the watermark into a predetermined location of a content on a real time basis (S820). For example, the predetermined location may be a location where a change in the sound amplitude is great or an amplitude is great when the watermark is in the form of the sound. When the watermark is in the form of the image, one frame may be divided into a plurality of areas of a predetermined size and the watermark may be inserted into each area. Also, the watermark may be inserted into a specific image area.

The content providing apparatus may transmit the content into which the watermark is inserted (S830). The content providing apparatus may transmit the content to a display apparatus. The display apparatus may play back the content into which the watermark is inserted.

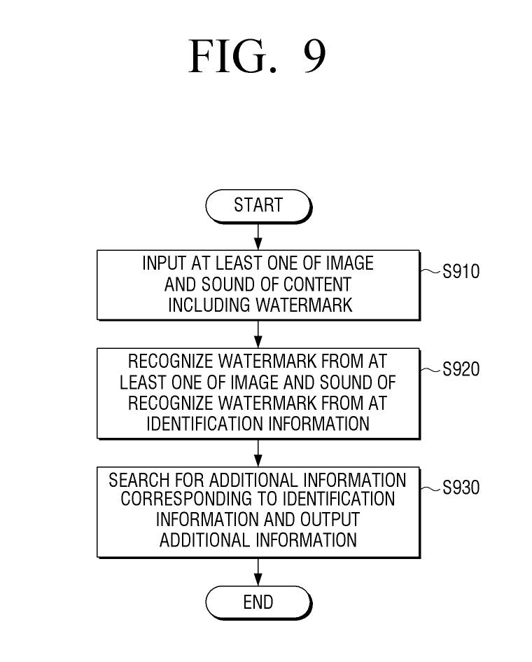

FIG. 9 is a flowchart illustrating a control method of a terminal apparatus.

Referring to FIG. 9, the terminal apparatus receives input of at least one of an image and sound of a content including a watermark from a display apparatus (S910). The terminal apparatus may receive input of the image of the content using a camera, for example, or may receive input of the sound of the content using a microphone, for example. According to circumstances, the terminal apparatus may receive the watermark or identification information extracted from the watermark from the display apparatus through a communicator.

The terminal apparatus detects the watermark from the at least one of the image and the sound of the input content, and extracts identification information from the watermark (S920). The terminal apparatus searches for additional information corresponding to the identification information and outputs the additional information (S930). The terminal apparatus may search for the additional information corresponding to the identification information from a single portion of additional information or a plurality of portions of additional information stored in the terminal apparatus. Also, the terminal apparatus may transmit the identification information to a server and may receive searched additional information from the server.

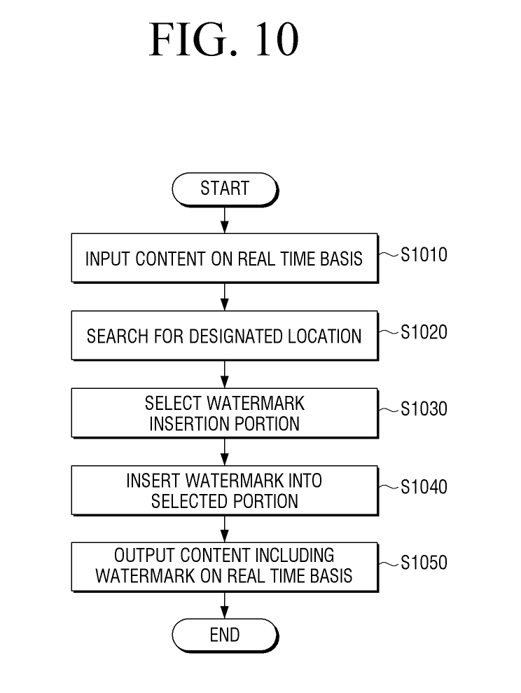

FIG. 10 is a flowchart illustrating a control method of a content providing apparatus according to another exemplary embodiment.

Referring to FIG. 10, the content providing apparatus receives input of a content on a real time basis (S1010). For example, the content providing apparatus may receive input of a broadcast content from a broadcasting source, etc.

The content providing apparatus searches for a designated location according to a user command (S1020). For example, the designated location may be a location where a change in the sound amplitude is great or an amplitude is great when a watermark is in the form of sound. When the watermark is in the form of an image, the designated location may be one of a plurality of areas of a predetermined size that are divided from one frame, or may be a specific image area. The content providing apparatus selects a portion into which the watermark is to be inserted (S1030).

The content providing apparatus inserts the watermark into the selected portion (S1040). The content providing apparatus may receive input of the content on a real time basis, search for the designated location, and may insert the watermark into the designated location. The content providing apparatus outputs the content including the watermark on a real time basis (S1050).

The content into which the watermark is inserted as described above may be received by a display apparatus and identification information may be extracted by the display apparatus or a terminal apparatus.

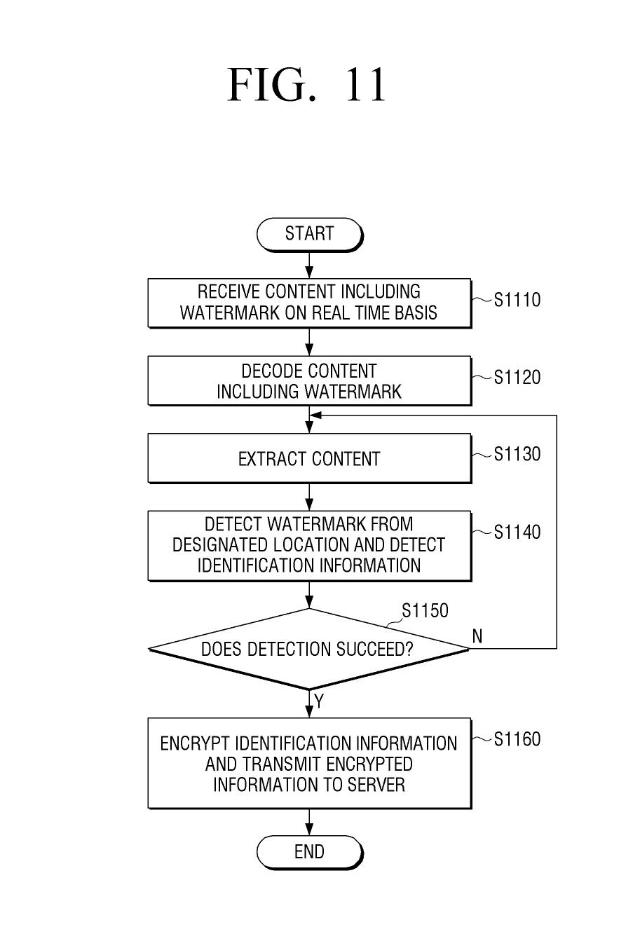

FIG. 11 is a flowchart illustrating a method for extracting a watermark according to an exemplary embodiment.

Referring to FIG. 11, a display apparatus receives a content into which a watermark is inserted on a real time basis (S1110). The display apparatus decodes the content into which the watermark is inserted (S1120). The display apparatus may include a controller (not shown) and the controller may include a decoder. Alternatively, the decoder (not shown) may be implemented separately from the controller. The decoder decodes the received content.

The display apparatus extracts the content (S1130). The content decoded by the decoder may be hooked. The display apparatus detects the watermark from a designated location and detects identification information (S1140). The display apparatus may detect the watermark and the identification information by hooking the content. Also, the display apparatus may sample the content when hooking the content. The display apparatus may include a controller (not shown) or may include a signal processor (not shown) separately from the controller. The controller or the signal processor may detect the watermark, detect the identification information, and hook and sample the content.

The display apparatus determines whether the identification information is detected or not (S1150). When the identification information is not detected, the display apparatus extracts the content again (S1130). The display apparatus may repeatedly extract the content until the watermark is detected. Also, the display apparatus may repeatedly extract the content for a predetermined time or a predetermined number of times.

When the display apparatus detects the identification information, the display apparatus encrypts the identification information and transmits the identification information to a server (S1160). The display apparatus may encrypt the identification information using the controller (not shown) and may transmit the encrypted identification information through a communicator (not shown).

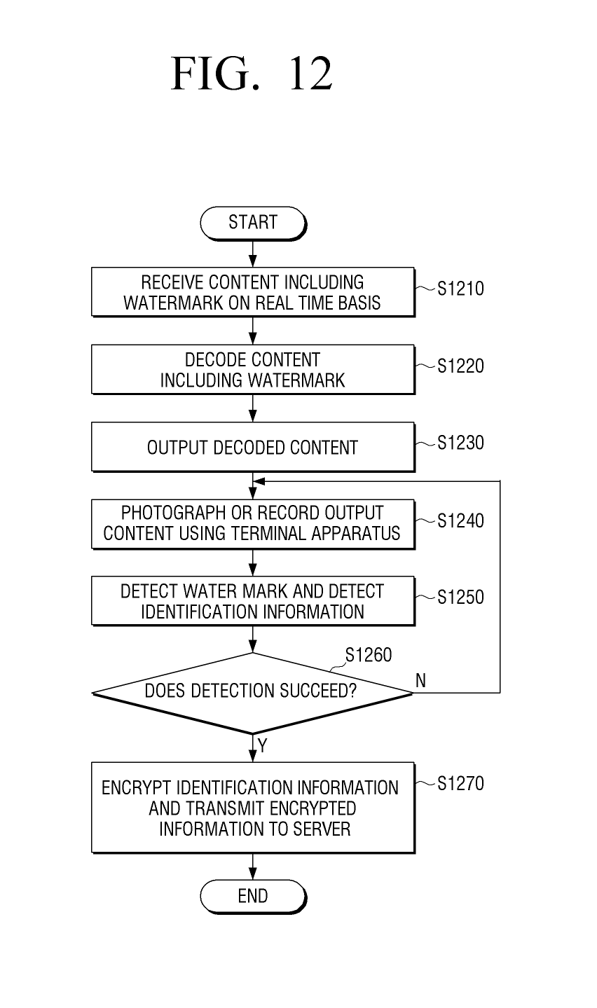

FIG. 12 is a flowchart illustrating a method for extracting a watermark according to another exemplary embodiment.

Referring to FIG. 12, a display apparatus receives a content including a watermark on a real time basis (S1210). The display apparatus decodes the content including the watermark (S1220). The display apparatus outputs the decoded content (S1230). The process of outputting the content from the display apparatus has been described above and thus a detailed description thereof is omitted.

A terminal apparatus may perform at least one of photographing and recording the output content (S1240), for example. The content may be photographed by a camera provided in the terminal apparatus and may be recorded by a microphone provided in the terminal apparatus. The terminal apparatus detects the watermark and detects identification information (S1250). The terminal apparatus may detect the watermark and the identification information by hooking the content. Also, the terminal apparatus may sample the content when hooking the content. A controller of the terminal apparatus may perform the hooking and sampling processes.

The terminal apparatus determines whether the identification information is detected or not (S1260). When the identification information is not detected, the terminal apparatus performs at least one of photographing and recording the content again (S1240). When the identification information is not detected, the terminal apparatus may automatically photograph or record the content. Also, the terminal apparatus may output a detection failure message to the user and may inform that the terminal apparatus will photograph or record again.

When the identification information is detected, the terminal apparatus encrypts the identification information and transmits the identification information to a server (S1270). The server may search for additional information corresponding to the identification information and then transmit the additional information to the terminal apparatus. The terminal apparatus receives the additional information and outputs the additional information.

The above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM disks, DVDs and Blu-rays; magneto-optical media such as optical discs; and hardware devices that are specially to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may act as one or more software modules in order to perform the operations of the above-described embodiments, or vice versa.

The control method of the content providing apparatus according to the above-described various exemplary embodiments may be implemented as a program and may be provided to the content providing apparatus. Also, the control method of the terminal apparatus may be implemented as a program and may be provided to the terminal apparatus.

For example, a non-transitory computer readable medium which stores a program to perform: generating a watermark, inserting the watermark into a predetermined location of a content on a real time basis, and transmitting the content into which the watermark is inserted may be provided to the content providing apparatus.

Also, a non-transitory computer readable medium which stores a program to perform: receiving input of at least one of an image and sound of a content including a watermark from a display apparatus, detecting a watermark from at least one of the image and the sound of the input content and extracting identification information from the watermark, and searching for additional information corresponding to the identification information and outputting the additional information may be provided to the terminal apparatus.

The foregoing exemplary embodiments and advantages are merely exemplary and are not to be construed as limiting the present inventive concept. The exemplary embodiments may be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A content providing apparatus comprising:
a generator to generate a watermark;
an inserter to insert the watermark into a predetermined location of a content on a real time basis; and
a communicator to transmit the content into which the watermark is inserted.

2. The content providing apparatus as claimed in claim 1, wherein the watermark is in a form of at least one of sound and an image.

3. The content providing apparatus as claimed in claim 2, wherein, when the watermark is in the form of the image, the inserter divides a frame constituting the content in a plurality of areas and inserts the watermark into the plurality of areas.

4. A terminal apparatus comprising:
an inputter to receive input of at least one of an image and sound of a content including a watermark from a display apparatus;
a controller to detect the watermark from the at least one of the image and the sound of the content and extract identification information from the watermark; and
an outputter to search for additional information corresponding to the identification information and output the additional information.

5. The terminal apparatus as claimed in claim 4, further comprising a storage to store at least one portion of additional information,
wherein the controller searches for the additional information corresponding to the identification information from the at least one portion of additional information stored in the storage.

6. The terminal apparatus as claimed in claim 4, further comprising a communicator to transmit the identification information to a server,
wherein the communicator receives the additional information which is searched using the identification information from the server.

7. An information providing system comprising:
a content providing apparatus to generate a watermark, insert the watermark into a predetermined location of a content on a real time basis, and transmit the content;
a display apparatus to receive the content into which the watermark is inserted and output the content; and
a terminal apparatus to receive input of at least one of an image and sound of the content comprising the watermark from the display apparatus, detect the watermark, extract identification information from the watermark, and output corresponding additional information.

8. The information providing system as claimed in claim 7, wherein, when the watermark is in a form of an image, the content providing apparatus divides a frame constituting the content into a plurality of areas and inserts the watermark into the plurality of areas.

9. A control method of a content providing apparatus, the method comprising:
generating a watermark;
inserting the watermark into a predetermined location of a content on a real time basis; and
transmitting the content into which the watermark is inserted.

10. The method as claimed in claim 9, wherein the watermarks is in a form of at least one of sound and an image.

11. The method as claimed in claim 10, wherein the inserting includes, when the watermark is in the form of the image, dividing a frame constituting the content into a plurality of areas and inserting the watermark into the plurality of areas.

12. A control method of a terminal apparatus, the method comprising:
receiving input of at least one of an image and sound of a content including a watermark from a display apparatus;
detecting the watermark from the at least one of the image and the sound of the content, and extracting identification information from the watermark; and
searching for additional information corresponding to the identification information and outputting the additional information.

13. The method as claimed in claim 12, wherein the searching further includes searching for the additional information corresponding to the identification information from at least one portion of additional information which is stored.

14. The method as claimed in claim 12, further comprising:
transmitting the identification information to a server; and
receiving the additional information which is searched using the identification from the server.

15. The content providing apparatus as claimed in claim 2, wherein the predetermined location is a location where a change in amplitude of the sound is great when a watermark is in the form of sound.

16. The method as claimed in claim 10, wherein the predetermined location is a location where a change in amplitude of the sound is great when a watermark is in the form of sound.

17. At least one non-transitory computer readable medium storing computer readable instruction to control at least one processor to implement the method of claim 8.

18. At least one non-transitory computer readable medium storing computer readable instruction to control at least one processor to implement the method of claim 12.
